(19) United States
(12) Patent Application Publication
(10) Pub. No.: US 2007/0215597 A1
(43) Pub. Date: Sep. 20, 2007

(54) HEATING DEVICE AND MANUFACTURING METHOD THEREOF

(75) Inventors: Yoshinobu Goto, Nagoya-shi (JP); Hisakazu Okajima, Nishikasugai-gun (JP)

Correspondence Address: BURR & BROWN, PO BOX 7068, SYRACUSE, NY, 13261-7068, US

(73) Assignee: NGK Insulators, Ltd., Nagoya-Shi (JP)

(21) Appl. No.: 11/687,919

(22) Filed: Mar. 19, 2007

(30) Foreign Application Priority Data
Mar. 20, 2006 (JP) 2006-076641

(51) Int. Cl. H05B 3/68

(52) U.S. Cl. 219/443.1

(57) ABSTRACT

A heating device includes: a plate-shaped heating substrate; and a hollow rod material an end face of which is joined to one surface of the heating substrate, and the heating substrate includes a lateral surface portion and a concave surface portion in the vicinity of a joint with the hollow rod material. The lateral surface portion forms a same plane surface with an outer peripheral surface of the hollow rod material, and the concave surface portion connects to the lateral surface portion. Moreover, an edge of a joint interface of the heating substrate and the hollow rod material is located between the lateral surface portion of the heating substrate and the outer peripheral surface of the hollow rod material.

### CROSS-REFERENCE TO RELATED APPLICATION

This application is based upon and claims the benefit of priority from Patent Application No. 2006-76641 filed on Mar. 20, 2006, in the Japanese Patent Office, of which the contents are incorporated herein by reference.

### BACKGROUND OF THE INVENTION

1. Field of the Invention

The present invention relates to a heating device and, more specifically, relates to a heating device to heat a wafer used as a substrate in a semiconductor device manufacturing process and another plate-shaped material to be heated and a manufacturing method thereof.

2. Description of Related Art

In the semiconductor device manufacturing process, a heating process is performed to form an oxide film and the like on a wafer using a semiconductor manufacturing apparatus. One of such heating devices to heat wafers in the semiconductor manufacturing apparatus is a ceramic heater with a wire resistance heating element embedded in a disk-shaped ceramic substrate having a heating surface. This ceramic heater is advantageously suitable for not only a film forming apparatus used for the semiconductor manufacturing process but also a surface processing apparatus which performs dry etching for the surface of a plate-shaped material to be heated.

The ceramic heater includes a ceramic substrate and a hollow rod material joined to support the ceramic substrate. This hollow rod material is a hollow cylinder. An end face of the rod material is fixed to a surface opposite to the heating surface of the ceramic substrate, that is, a joint surface, by solid-phase bonding or liquid-phase bonding.

From the viewpoint of a structure where the ceramic substrate is attached to the hollow rod material, there is a ceramic heater including a rounded portion between the joint surface of the ceramic substrate and the outer peripheral surface of the hollow rod material (Japanese Patent Laid-open No. 2004-247745).

In the conventional ceramic heater provided with such a rounded portion, the joint surface of the ceramic substrate and the outer peripheral surface of the hollow rod material are smoothly connected with a curved surface of the rounded portion formed in the joint of the both. In such a ceramic heater, when the joint interface between the ceramic substrate and the hollow rod material is in contact with the curved surface of the rounded portion, in some cases, cracks occur from the part where this joint interface is in contact with the rounded portion after long use of the heating apparatus and then propagate along this joint interface, thus causing separation in the joint interface of the ceramic substrate and the hollow rod material.

An object of the present invention is therefore to provide a heating apparatus capable of effectively preventing occurrence of cracks in the joint interface between the ceramic substrate and the hollow rod material and thus increasing the reliability and to provide an advantageous manufacturing method thereof.

### SUMMARY OF THE INVENTION

To achieve the aforementioned object, a heating device according to the present invention includes: a plate-shaped heating substrate; and a hollow rod material an end face of which is joined to one surface of the heating substrate, and the heating substrate includes a lateral surface portion and a concave surface portion in the vicinity of a joint with the hollow rod material. The lateral surface portion forms a same plane surface with an outer peripheral surface of the hollow rod material, and the concave surface portion connects to the lateral surface portion. Moreover, an edge of a joint interface of the heating substrate and the hollow rod material is located between the lateral surface portion of the heating substrate and the outer peripheral surface of the hollow rod material.

Preferably, a curvature radius R of the concave surface portion is 1 to 10 mm. Moreover, the concave surface portion is configured to have an elliptic arc shape in a section including a central axis line of the hollow rod material, thus further increasing the reliability. Preferably, the concave surface portion has a center line average roughness Ra of not more than 0.8 μm.

A method of manufacturing a heating device according to the present invention includes the steps of: joining an end face of a hollow rod material to one surface of a heating substrate; and grinding a concave surface portion formed in the heating substrate in the vicinity of a joint of the heating substrate and the hollow rod material. The grinding is performed under conditions where grain size and feed speed of a grinding wheel are No. 325 or more and 0.2 mm/min or less, respectively.

According to the heating device of the present invention, it is possible to suppress the occurrence of cracks originating from the joint interface between the heating substrate and the hollow rod material and increase the reliability of the heating device.

### BRIEF DESCRIPTION OF THE DRAWINGS

The above and further objects, features and advantages of the invention will more fully appear in the detailed description of embodiments of the invention, when the same is read in conjunction with the drawings, in which:

FIG. 1 is a schematic longitudinal sectional view showing an embodiment of a heating device according to the present invention;

FIG. 2A is a schematic longitudinal sectional view showing another embodiment of the heating device according to the present invention;

FIG. 2B is an enlarged view of a part of FIG. 2A;

FIG. 3 is a schematic longitudinal sectional view showing a heating device of a comparative example; and

FIG. 4 is a schematic longitudinal sectional view showing a heating device of another comparative example.

### DETAILED DESCRIPTION OF THE INVENTION

Hereinafter, a description is given of embodiments of a heating device of the present invention using the drawings.

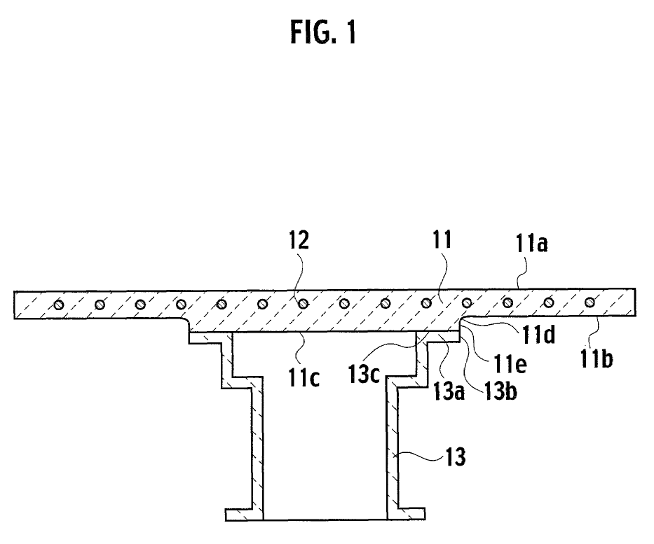

FIG. 1 is a schematic longitudinal sectional view of an embodiment of a heating device according to the present invention. The heating device shown in FIG. 1 includes a disk-shaped ceramic substrate 11 as a heating substrate. The ceramic substrate 11 includes a resistance heating element 12 embedded inside. By supplying power to the resistance heating element 12, the resistance heating element 12 generates heat in the ceramic substrate 11. This heated ceramic substrate 11 heats a material to be heated (for example, a semiconductor wafer) set on the ceramic substrate 11. One surface of the disk-shaped ceramic substrate 11 serves as a heating surface 11a, to which the material to be heated is attached for heating. The other surface thereof opposite to the heating surface 11a serves as a joint surface 11b, to which a shaft 13 as a hollow rod material supporting the ceramic substrate 11 is joined. The ceramic substrate 11 is thicker around central part of the joint surface 11b than around the outer peripheral edge. The shaft 13 is joined to a surface 11c of the central part.

The shaft 13 is hollow and substantially cylindrical. In internal space of the shaft 13, lead wires or power supply rods through which power is supplied to the resistance heating element 12 of the ceramic substrate 11 are disposed. Moreover, when the ceramic substrate 11 includes an electrode for an electrostatic chuck or a high-frequency electrode, lead wires connected to the electrode embedded in the ceramic substrate 11 are disposed in the internal space of the shaft 13.

The shaft 13 includes a flange portion 13a formed in an end which is joined to the ceramic substrate 11. An outer peripheral surface 13b of the flange portion 13a is linear in the longitudinal section shown in the drawing. The shaft 13 is joined to the ceramic substrate 11 by solid-phase or liquid-phase bonding with an end face 13c of the flange portion 13a being abutted on the surface 11c of the central part of the ceramic substrate 11.

The ceramic substrate 11 includes a concave surface portion 11d smoothly connecting to the plane of the joint surface 11b in the vicinity of the joint to the shaft 13. Moreover, the ceramic substrate 11 includes a lateral surface portion 11e, which forms a same plane with the outer peripheral surface 13b of the flange portion 13a of the joined shaft 13 and connects to the outer peripheral surface 13b and concave surface portion 11d without a gap linearly in the longitudinal section. The outer peripheral edge of the joint interface between the ceramic substrate 11 and the shaft 13 is located between the lateral surface portion 11e of the ceramic substrate 11 and the outer peripheral surface 13b of the flange portion 13a of the shaft 13. In other words, unlike the conventional ceramic substrate, the edge of the joint interface is not in contact with the concave surface portion (the rounded portion).

In a conventional heating device whose edge of the joint interface between the ceramic substrate and the shaft is in contact with the surface of the concave surface portion (the rounded portion), cracks occurring from the edge of the joint interface are considered to be caused by thermal stress during use of the heating device. Specifically, the ceramic substrate is uniformly heated on the heating surface side by heat generated by the resistance heating element, but temperature of the part of the ceramic substrate connected to the shaft is lower than that of the other part because of heat transfer to the shaft. In the ceramic substrate, thermal stress is produced in the radial direction by such temperature gradient and is concentrated on the outer peripheral edge of the joint interface, thus causing cracks. The joint interface generally has less strength than the other balk part. Accordingly, once cracks occur, the cracks propagate along this joint interface, eventually causing separation of the ceramic substrate and the shaft. Moreover, the joint interface is susceptible to corrosion and oxidation by atmosphere gas during use of the heating device and is gradually reduced in strength. This also leads to separation of the joint. In the internal space of the shaft, a conducting rod and lead wires are disposed. Accordingly, in order to protect these conducting rod and lead wires from corrosive gas, it is necessary to suppress the separation of joint and increase the reliability.

The concave surface portion (the rounded portion) formed in the conventional ceramic substrate is to reduce the concentration of thermal stress. However, when the joint interface is in contact with the surface of the rounded portion, cracks occur in some cases.

On the other hand, in the heating device of the embodiment shown in FIG. 1, the concave surface portion 11d is formed only in the ceramic substrate. The ceramic substrate 11 includes not only the concave surface portion 11d but also a lateral surface portion 11e, which forms a same plane in conjunction with the outer peripheral surface 13b of the flange portion 13a of the shaft 13. The edge of the joint interface is therefore located between the lateral surface portion 11e of the ceramic substrate 11 and the outer peripheral surface 13b of the shaft 13, which are smoothly connected to each other. The joint interface perpendicularly intersects the lateral surface portion 11e of the ceramic substrate 11 and the outer peripheral surface 13b of the shaft 13. Accordingly, the edge of the joint interface has high resistance to the joint thermal stress, and the concentration of stress is effectively reduced, thus suppressing the occurrence of cracks. The reliability can be therefore increased.

Preferably, the concave surface portion 11d has a curvature radius of 1 to 10 mm. When the curvature radius is 0.5 mm, which is extremely small, the effect of the concave surface portion 11d is small. Accordingly, the stress concentrated on the edge becomes high, and cracks may occur. Moreover, the larger the curvature radius of the concave surface portion 11d is, the lower the stress applied to the outer peripheral edge of the joint interface is. However, to ensure larger curvature radius, the ceramic substrate 11 before processing needs to be thicker. Increasing the thickness of the ceramic substrate 11 may reduce the strength of the ceramic substrate 11 itself. This is because a ceramic structure with larger volume has a higher probability of including internal defects. From the viewpoint of the internal defects, there are limits to increase the thickness. In addition, since only the central part of the ceramic substrate has large heat capacity, an increase in temperature in the central part is delayed at heating. This produces tensile stress around the center, and the central part could be damaged. Moreover, the concave surface portion 11d is formed by removing part of the ceramic substrate 11 other than the central part by grinding. Accordingly, as the curvature radius of the concave surface portion 11d is increased and the initial thickness of the ceramic substrate 11 before grinding is therefore increased, the price for processing increases, thus leading to an increase in costs. The curvature radius of the concave surface portion 11d is therefore preferably not more than 10 mm and, more preferably, 1 to 4 mm.

The thickness of the ceramic substrate 11 around the central part is preferably 2 to 50 mm and, more preferably, 5 to 30 mm. The above-described curvature radius of the concave surface portion 11d can be determined as a proper value smaller than the thickness of the ceramic substrate 11 according to the thickness of the ceramic substrate 11.

In terms of surface roughness of the curvature surface portion 11d, preferably, a center line average roughness Ra is not more than 0.8 μm. Studies by the inventor and the like revealed that cracks were more likely to occur in the curvature surface portion 11d with larger surface roughness when the curvature radius is the same. This is considered to be because defects are more likely to originate from the larger surface roughness. In terms of the surface roughness of the concave surface portion 11d, setting the center line average roughness Ra to not more than 0.8 μm effectively suppresses the occurrence of cracks, thus making it possible to further increase the reliability. Such adjustment of the center line average roughness Ra can be advantageously realized by grinding the concave surface portion in manufacturing of the ceramic substrate 11 under conditions where grain size of a grinding wheel is No. 325 or more and feed speed thereof is 0.2 mm/min.

Preferably, the lateral surface portion 11e, which separates the concave surface portion 11d of the ceramic substrate 11 from the joint interface, has a linear length of 0.5 to 2.0 mm. Increasing the linear length of the lateral surface portion 11e requires an increase in thickness of the ceramic substrate before processing, thus increasing the price for processing. Moreover, if the lateral surface portion 11e is excessively short, the joint interface is located adjacent to the concave surface portion 11d, and the effect of the present invention cannot be sufficiently obtained.

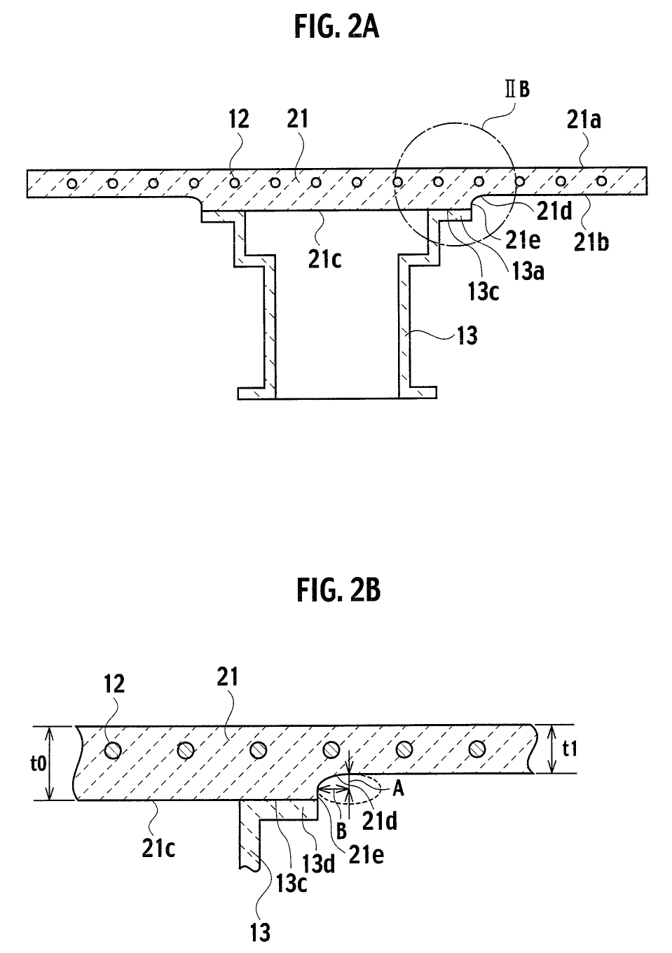

Next, a description is given of another embodiment of the heating device of the present invention using FIGS. 2A and 2B.

FIG. 2A is a schematic longitudinal sectional view of the another embodiment of the heating device of the present invention, and FIG. 2B is an enlargement view of an area indicated by reference numeral IIB of FIG. 2A. In FIGS. 2A and 2B, same members as those of FIG. 1 are given same reference numerals, and a redundant description is omitted below.

The heating device of the embodiment shown in FIGS. 2A and 2B includes a ceramic substrate 21 and the shaft 13. The ceramic substrate 21 includes a heating surface 21a and a joint surface 21b. The ceramic substrate 21 is thicker around the central part of the joint surface 21b than around the outer peripheral edge. The shaft 13 is joined to a surface 21c of the center part.

The ceramic substrate 21 includes a concave surface portion 21d in the vicinity of the joint to the shaft 13. The concave surface portion 21d smoothly connects to a plane of the joint surface 21b. Moreover, the ceramic substrate 21 includes a lateral surface portion 21e. The lateral surface portion 21e connects to the concave surface portion 21b and the outer peripheral surface 13b of the flange portion 13a of the shaft 13 without a gap linearly in the longitudinal section shown in the drawing.

The concave surface portion 21d has a shape of an arc of an ellipse in a section including a central axis line of the shaft 13. The major axis of the ellipse is in parallel to the joint surface 21b of the ceramic substrate 21, and the minor axis thereof is perpendicular to the joint surface 21b of the ceramic substrate 21. The embodiment shown in FIGS. 2A and 2B in that the sectional shape of the concave surface portion is an elliptic arc is different from the embodiment shown in FIG. 1.

The concave surface portion 21d has elliptic arc shape in a section including the central axis line of the shaft 13 in the embodiment shown in FIGS. 2A and 2B. Accordingly, compared to the embodiment shown in FIG. 1, the embodiment shown in FIGS. 2A and 2B can effectively provide the same effect without increasing the thickness (t0 shown in FIG. 2B) of the ceramic substrate as that provided by increasing the curvature radius. Moreover, the concave surface portion 21d is an arc with curvature exceedingly smooth in an area connected to the lateral surface portion 21e. Accordingly, the thermal stress can be further reduced than that in the embodiment shown in FIG. 1.

Preferably, the length of a semiminor axis A of the arc of the concave surface portion 21d is 1 to 10 mm, and the length of a semimajor axis B is such a value that has a ratio B/A to the length of the semiminor axis A of 1.2 to 10. More preferably, the length of a semiminor axis A is 1 to 4 mm, and the semimajor axis B is 1.5 to 5 in a ratio B/A where A is length of the semiminor axis A.

The length of the semiminor axis A of not more than 1 mm has not so much effect of the concave surface portion 21d. Moreover, if the semiminor axis A is longer than 10 mm, the thickness t of the ceramic substrate 21 needs to be large, which increases the volume of the ceramic substrate 11 and could reduce the strength. Moreover, the concave surface portion 21d is formed by removing the part other than the central part of the ceramic substrate 21 by grinding. Accordingly, as the semiminor axis is increased and the initial thickness of the ceramic substrate 21 before grinding is therefore increased, the price for processing increases, thus leading to an increase in costs. It is therefore preferable that the length of the semiminor axis is not more than 10 mm and, more preferably, the range is 1 to 4 mm.

When the ratio B/A in length of the semimajor axis B to the semiminor axis A is lower than 1.5, the sectional shape of the concave surface portion 21d is close to a perfect circle and has not so much effect characteristic to this embodiment. When the ratio B/A in length of the semimajor axis B to the semiminor axis A is higher than 10, the heat capacity around the central part of the ceramic substrate 21 is excessively large, which could degrade the heat uniformity or require more time to heat the ceramic substrate.

Also in the embodiment shown in FIGS. 2A and 2B, the thickness (to shown in FIG. 2B) of the ceramic substrate 21 around the central part is preferably 2 to 50 mm and more preferably 5 to 30 mm. The curvature radius of the concave surface portion 21d can be determined as a proper value smaller than the thickness of the ceramic substrate 21 around the central part according to the thickness of the ceramic substrate 21.

In terms of the surface roughness of the concave surface portion 21d, preferably, the center line average roughness Ra is not more than 0.8 μm. The concave surface portion 21d with a center line average roughness Ra of not more than 0.8 μm can effectively suppress the occurrence of cracks, thus increasing the reliability. Such adjustment of the center line average roughness Ra can be advantageously realized by grinding the concave surface portion in manufacturing of the ceramic substrate 21 under the conditions where the grain size of the grinding wheel is No. 325 or more and the feed speed thereof is not more than 0.2 mm/min.

Preferably, the lateral surface portion 21e, which separates the concave surface portion 21d from the joint interface, has a linear length of 0.5 to 2.0 mm as that of the embodiment shown in FIG. 1. Increasing the linear length of the lateral surface portion 21e requires an increase in thickness of the ceramic substrate before processing, thus increasing the price for processing. Moreover, if the linear length of the lateral surface portion 21e is excessively short, the joint interface is located adjacent to the concave surface portion 2d, and the effect of the present invention cannot be sufficiently obtained.

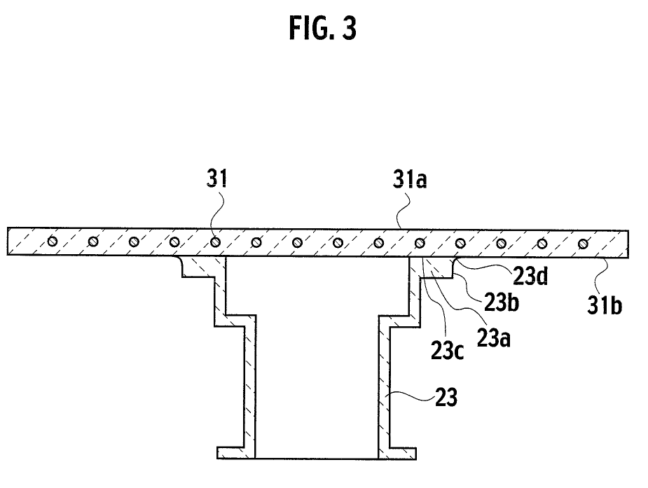

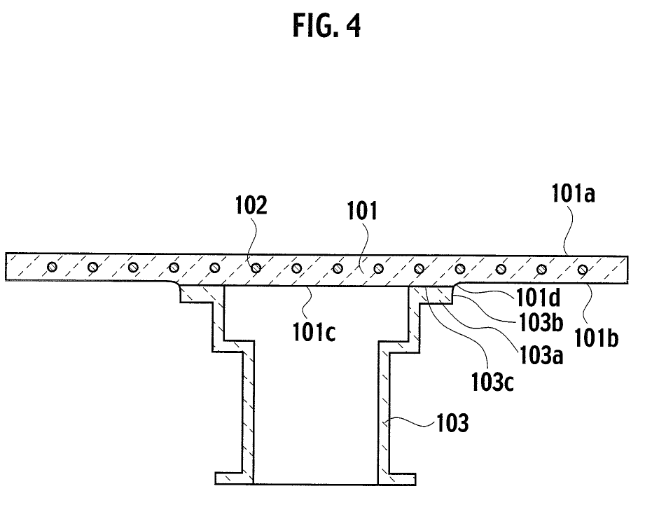

Next, a description is given of heating devices of comparative examples using FIGS. 3 and 4.

FIG. 3 is a schematic longitudinal sectional view of a heating device of a comparative example. The heating device shown in the same drawing includes a ceramic substrate 31 and a shaft 23, which is joined to a joint surface 31b of the ceramic substrate 31 opposite to a heating surface 31a. In the vicinity of a joint of the ceramic substrate 31 and the shaft 23 in this comparative example, a flange portion 23a includes an outer peripheral surface 23b and a concave surface portion 23d, which smoothly connects to the outer peripheral surface 23b. The joint interface between the ceramic substrate 31 and the shaft 23 is therefore not in contact with the surface of the concave surface portion 23d. It is therefore possible to prevent cracks from occurring from the outer peripheral edge of the joint interface. However, it is difficult to produce the ceramic shaft 23 shaped as shown in FIG. 3 by a known manufacturing method, and the embodiments shown in FIG. 1 and FIGS. 2A and 2B are advantageous considering an actual manufacturing method.

FIG. 4 is a schematic longitudinal sectional view of a heating device of another comparative example. The heating device in the same drawing includes a ceramic substrate 101; a resistance heating element 102, which is embedded in the ceramic substrate 101; and a shaft 103, which is joined to the joint surface 101b of the ceramic substrate 101 opposite to the heating surface 101a. The ceramic substrate 101 is thick around central part of the joint surface 101b, and the shaft 103 is joined to a surface 101c of the thick center part. In an end of the shaft 103, a flange portion 103a is formed. The flange portion 103a includes an outer peripheral surface 103b and an end face 103c.

In the vicinity of the joint of the ceramic substrate 101 and the shaft 103, a concave surface portion 101d is formed. The joint interface between the ceramic substrate 101 and the shaft 103 is in contact with the surface of the concave surface portion 101d. This comparative example is different from the embodiments shown in FIG. 1 and FIGS. 2A and 2B in this regard. In the comparative example shown in FIG. 4, cracks may occur from the edge of the joint interface which is located within the surface of the concave surface portion 101d.

Above description is given of the embodiments of the heating device according to the present invention using the drawings. However, in the heating device according to the present invention, the structure of the ceramic substrates 11 and 21 are not limited to the embodiments shown in the drawings. Moreover, the material of the ceramic substrates 11 and 12 is preferably nitride ceramics or an alumina-silicon carbide composite material such as aluminum nitride, silicon carbide, silicon nitride, boron nitride, mullite, saialon, and the like. Moreover, the material of the ceramic substrates 11 and 12 is not limited these materials and may be a known ceramics material. To provide the ceramic substrate with high resistance to corrosive gas such as halogen gas contained in the atmosphere during use of the heating device, aluminum nitride and alumina are particularly preferred. Moreover, the structure of the present invention can be applied to not only the ceramic substrate but also a heating device including a substrate made of heat resistant metal (heat resistant stainless steel or Ni-base alloy such as Inconel).

The shaft is preferably made of a same material as that of the ceramic substrate from the viewpoint of reducing thermal stress as much as possible.

The heating device of the present invention is manufactured through a process to produce the ceramic substrate, a process to produce the shaft, a process to join the ceramic substrate and the shaft. These processes are performed according to ordinary methods.

The concave surface portion of the ceramic substrate characteristic to the heating device of the present invention can be formed by grinding after the process to produce the ceramic substrate and/or the process to join the ceramic substrate and the shaft. It is more preferable that finish processing of this grinding is performed under conditions where the grain size of the grinding wheel is No. 325 or more and the feed speed thereof is not more than 0.2 mm/min. Grinding under such conditions can suppress the occurrence of cracks more effectively.

Specifically, in terms of the surface roughness of the concave surface portion, the minimum center line average roughness Ra that can be obtained with an ordinary grinding method is not smaller than about 0.8 μm even if the grain size and feed speed of the grinding wheel are varied, and it is difficult to adjust the center line average roughness Ra to a value smaller than about 0.8 μm. However, studies by the inventor and the like revealed that by reducing the grain size of the grinding wheel and reducing feed speed thereof, the joint strength is further increased even though the surface roughness of the concave surface portion does not change. This is considered to be because by reducing grain size of the grinding wheel and reducing the feed speed thereof, processing damage of the concave surface portion, that is, micro-cracks, are reduced. Accordingly, it is more preferable that the finish processing in the grinding is preformed under the conditions where the grain size of the grinding wheel is No. 325 or more and the feed speed thereof is not more than 0.2 mm/min.

### EXAMPLES

### [Examination 1]

A plurality of heating devices each including the concave surface portion in the vicinity of the joint of the ceramic substrate and the shaft were manufactured with the shape and position of the concave surface portion varied. Each heating device was manufactured by producing the ceramic substrate and shaft using AlN powder as a raw material by means of press-molding and sintering and then solid-phase joining of the both.

The outer diameter of the ceramic substrate and thickness (t1 of FIG. 2B) thereof in the periphery were 348 mm and 25 mm respectively, which were not changed. The curvature radius of the concave surface portion and the thickness (to of FIG. 2B) of the ceramic substrate in the central part were variously changed. The flange portion of the shaft of each heating substrate had an outer diameter of 75 mm, an inner diameter of 52 mm, and a thickness (axial length of the outer peripheral portion) of 5 mm. In the processing of the concave surface portions, the grain size, rotational speed, and feed speed of the grinding wheel were set to No. 200, 6000 rpm, and 0.2 mm/min, respectively. The center line average roughness Ra of the concave surface portions was 0.9 μm. Thus-obtained heating devices were put in a chamber with NF₃ gas atmosphere at 400 Torr and then heated at 700° C. After 24 hours continuous operation, the temperature was once lowered to 200° C. and again raised to 700° C. Such a thermal test was performed for a predetermined period of time, and then presence of cracks was examined.

The results thereof are shown in Table 1.

TABLE 1

| | | | Thickness of | | | | |
|---|---|---|---|---|---|---|---|
| | Position | Curvature | Ceramic | | | | |
| | Of | Radius of | substrate | | | | |
| | Concave | Concave | around | Time | | | |
| | Surface | Surface | Central part | After 1 | After 6 | After 1 | After 2 |
| | Portion | Portion (mm) | (mm) | Day | Months | Year | Years |
| Comparative | Joint of | 0.1 | 25 | Cracks | | | |
| Example 1 | Shaft | | | | | | |
| Comparative | Joint of | 0.5 | 25.2 | Cracks | | | |
| Example 2 | Shaft | | | | | | |
| Comparative | Joint of | 1.0 | 25.5 | Cracks | | | |
| Example 3 | Shaft | | | | | | |
| Comparative | Joint of | 2.0 | 26 | Cracks | | | |
| Example 4 | Shaft | | | | | | |
| Comparative | Joint of | 3.0 | 27.5 | No Cracks | Cracks | | |
| Example 5 | Shaft | | | | | | |
| Comparative | Ceramic | 0.5 | 26.5 | No Cracks | Cracks | | |
| Example 6 | Substrate | | | | | | |
| Example 1 | Ceramic | 1.0 | 27 | No Cracks | No Cracks | No Cracks | Cracks |
| | Substrate | | | | | | |
| Example 2 | Ceramic | 2.0 | 28 | No Cracks | No Cracks | No Cracks | Cracks |
| | Substrate | | | | | | |
| Example 3 | Ceramic | 4.0 | 30 | No Cracks | No Cracks | No Cracks | Cracks |
| | Substrate | | | | | | |
| Example 4 | Ceramic | 5.0 | 31 | No Cracks | No Cracks | Cracks | |
| | Substrate | | | | | | |
| Example 5 | Ceramic | 10.0 | 36 | No Cracks | No Cracks | Cracks | |
| | Substrate | | | | | | |
| Comparative | Ceramic | 12.0 | 38 | Cracks | | | |
| Example 7 | Substrate | | | | | | |
| Example 6 | Ceramic | Ellipse | 26.2 | No Cracks | No Cracks | No Cracks | Cracks |
| | Substrate | A = 0.5, B = 1.0 | | | | | |
| Example 7 | Ceramic | Ellipse | 27 | No Cracks | No Cracks | No Cracks | No Cracks |
| | Substrate | A = 1.0, B = 3.0 | | | | | |

As apparent from Table 1, in Comparative Examples 1 to 5, each concave surface portion in the vicinity of the joint was located adjacent to the joint interface of the ceramic substrate and the shaft. In Comparative Examples 1 to 4, cracks occurred after a lapse of one day. Comparative Example 5, whose curvature radius was large among Comparative Examples 1 to 5, had no defects observed for sixth months. This revealed that such a large curvature radius of about 3 mm was effective in suppressing the occurrence of cracks.

Examples 1 to 5 were examples according to the present invention in which the concave surface portions were located in the ceramic substrates and the lateral surface portions connecting to the concave surface portions had lengths of 0.5 to 2 mm. Apparent from Examples 1 to 5, when the curvature radius of the concave surface portion was 1 to 10 mm, no defects were observed for six months, showing excellent reliability. Especially Examples including the concave surface portions with curvature radii of 1 to 4 mm had no defects observed even after a year, showing especially excellent reliability. In Comparative Example 6, the curvature radius of the concave surface portion was 0.5 mm, which was excessively small, and the effect of the present invention was not effective. Comparative Example 7 was damaged during heating.

Examples 6 and 7 were examples according to the present invention in which the concave surface portions were located in the ceramic substrates and had elliptic sections and the lateral surface portions connecting to the concave surface portions had lengths of 1 to 2 mm. Apparent from Examples 6 and 7, the heating devices including the concave surface portions with elliptic sections had no defects observed even after one year, showing particularly excellent reliability. Comparison between Example 6 and Comparative Example 6, which had a curvature radius equal to the length of the semiminor axis of Example 6, and comparison between Example 7 with Comparative Example 1, which had a curvature radius equal to the length of the semiminor axis of Example 7, revealed that the concave surface portion with an elliptic section could provide higher reliability for the heating device than the concave surface portion with a circular section even when the thicknesses of the central parts of the ceramic substrates were the same.

### [Examination 2]

Examination was made for a relation between the surface roughness of the concave surface portion of the ceramic substrate and the joint strength. The heating devices used herein were made of same materials and had same size as those of the heating devices used in Examination 1.

The sectional shape of each of the concave surface portions was an arc of a perfect circle with a radius curvature of 2 mm. The thicknesses of each ceramic substrate near the central part and near the periphery were 28 mm and 25 mm, respectively.

The finish grinding was performed for the concave surface portions using grinding wheels with different grain sizes and changing the rotational speed and feed speed of the grinding wheels. As the results of the grinding, joint strength of the joint interfaces and the surface roughness of the concave surface portions are shown in Table 2. The strength of the joint interfaces was obtained by performing a cantilever bending test for cut-out test pieces.

TABLE 2

| | Grinding | Grinding | | Surface |
|---|---|---|---|---|
| Grinding | Wheel | Wheel Feed | | Roughness |
| Wheel | Rotational | Speed | Strength | (Ra) |
| Number | Speed (rpm) | (mm/Min) | (Mpa) | (μm) |
| #125 | 6000 | 1 | 130 | 1.4 |
| #125 | 6000 | 0.5 | 150 | 1.2 |
| #125 | 6000 | 0.2 | 180 | 1 |
| #125 | 6000 | 0.1 | 200 | 0.9 |
| #200 | 6000 | 1 | 160 | 1.2 |
| #200 | 6000 | 0.5 | 0.17 | 1.1 |
| #200 | 6000 | 0.2 | 200 | 0.9 |
| #200 | 6000 | 0.1 | 210 | 0.8 |
| #325 | 6000 | 1 | 250 | 1 |
| #325 | 6000 | 0.5 | 280 | 0.9 |
| #325 | 6000 | 0.2 | 330 | 0.8 |
| #325 | 6000 | 0.1 | 350 | 0.8 |
| #400 | 6000 | 1 | 250 | 0.9 |
| #400 | 6000 | 0.5 | 260 | 0.8 |
| #400 | 6000 | 0.2 | 330 | 0.8 |
| #400 | 6000 | 0.1 | 340 | 0.8 |

Table 2 revealed that setting the grain size (the number of the grinding wheel) to No. 325 or more and setting the feed speed thereof not more than 0.2 mm/min drastically increased the strength.

A heating device with a same shape as that of Example 4 in Table 1 was produced by processing the concave surface portion with a grinding wheel of No. 325 at a rotational speed of 6000 rpm and a feed speed of 0.2 mm/min and was subjected to a heating corrosion test under same conditions as those shown in Examination 1. As a result, no cracks occurred even after a lapse of two years. This revealed that setting the grain size (the number of the grinding wheel) to No. 325 or more and setting the feed speed to not more than 0.2 mm/min can further increase the reliability of the heating device.

While preferred embodiments of the present invention have been described using specific terms, such description is for illustrative purposes, and it is to be understood that changes and variations may be made without departing from the spring or scope of the claims.

What is claimed is:

1. A heating device, comprising:
a plate-shaped heating substrate; and
a hollow rod material an end face of which is joined to one surface of the heating substrate, wherein
the heating substrate includes a lateral surface portion and a concave surface portion in the vicinity of a joint with the hollow rod material, the lateral surface portion forming a same plane surface with an outer peripheral surface of the hollow rod material, the concave surface portion connecting to the lateral surface portion, and
an edge of a joint interface of the heating substrate and the hollow rod material is located between the lateral surface portion of the heating substrate and the outer peripheral surface of the hollow rod material.

2. The heating device according to claim 1, wherein
a curvature radius R of the concave surface portion is 1 to 10 mm.

3. The heating device according to claim 1, wherein
the concave surface portion has an elliptic arc shape in a section including a central axis line of the hollow rod material.

4. The heating device according to claim 1, wherein
the concave surface portion has a center line average roughness Ra of not more than 0.8 μm.

5. A method of manufacturing a heating device, comprising the steps of:
joining an end face of a hollow rod material to one surface of a heating substrate; and
grinding a concave surface portion formed in the heating substrate in the vicinity of a joint of the heating substrate and the hollow rod material, wherein
the grinding is performed under conditions where grain size and feed speed of a grinding wheel are No. 325 or more and 0.2 mm/min or less, respectively.
